(19) United States
(12) Patent Application Publication
(10) Pub. No.: US 2026/0296500 A1
(43) Pub. Date: Oct. 1, 2026

(54) VEHICLE CONTROL DEVICE, VEHICLE CONTROL METHOD, AND PROGRAM USING ROBUST PLANNING WITH IMPROVED OTHER VEHICLE PREDICTION

(71) Applicant: HONDA MOTOR CO., LTD., Minato-ku, Tokyo (JP)

(72) Inventors: Tim Puphal, Wako-shi (JP); Vipul Ramtekkar, Wako-shi (JP); Kenji Nishimiya, Wako-shi (JP)

(21) Appl. No.: 19/422,509

(22) Filed: Dec. 17, 2025

(30) Foreign Application Priority Data
Mar. 27, 2025 (JP) 2025-054293

(51) Int. Cl. B60W 60/00; B60W 30/095

(52) U.S. Cl. CPC B60W 60/0027; B60W 30/0956; B60W 60/0013; B60W 60/0015; B60W 60/0021

(57) ABSTRACT

A vehicle control device including a storage medium having stored thereon computer-readable instructions and a processor connected to the storage medium, the processor executing the computer-readable instructions to: acquire a plurality of predicted trajectories of another vehicle traveling near an own vehicle; select two predicted trajectories from among the plurality of predicted trajectories based on a first target trajectory of the own vehicle; establish a final predicted trajectory of another vehicle out of the selected two predicted trajectories based on at least one of an occurrence probability and risk value of the selected two predicted trajectories; generate a second target trajectory of the own vehicle based on the established final predicted trajectory; and control travel of the own vehicle according to the second target trajectory.

### CROSS-REFERENCE TO RELATED APPLICATION

This application is based upon and claims the benefit of priority from Japanese Patent Application No. 2025-054293, filed Mar. 27, 2025, the entire content of which is incorporated herein by reference.

### BACKGROUND

### Field of the Invention

The present invention relates to a vehicle control device, a vehicle control method, and a program using robust planning with improved other vehicle prediction.

### Description of Related Art

Conventionally, technologies for controlling vehicle travel have been known. For example, U.S. Pat. No. 11,535,262 describes a technology for identifying a profile of a vehicle occupant based on sensor data, and controlling vehicle travel according to the identified profile.

However, although the technology described in U.S. Pat. No. 11,535,262 identifies the state of a vehicle occupant, the technology does not identify the states of other vehicles near the vehicle. As a result, the technology fails to appropriately control vehicle travel according to the states of other vehicles.

### SUMMARY

The present invention has been made in view of the above-mentioned circumstances, and has an object to provide a vehicle control device, a vehicle control method, and a program using robust planning with improved other vehicle prediction, which are capable of appropriately controlling vehicle travel according to the states of other vehicles.

A vehicle control device, a vehicle control method, and a program using robust planning with improved other vehicle prediction according to the present invention adopt the following configuration.
(1): A vehicle control device according to one aspect of the present invention is a vehicle control device including a storage medium having stored thereon computer-readable instructions and a processor connected to the storage medium, the processor executing the computer-readable instructions to: acquire a plurality of predicted trajectories of another vehicle traveling near an own vehicle; select two predicted trajectories from among the plurality of predicted trajectories based on a first target trajectory of the own vehicle; establish a final predicted trajectory of another vehicle out of the selected two predicted trajectories based on at least one of an occurrence probability and risk value of the selected two predicted trajectories; generate a second target trajectory of the own vehicle based on the established final predicted trajectory; and control travel of the own vehicle according to the second target trajectory.
(2): In aspect (1), the first target trajectory of the own vehicle is a target trajectory that does not consider existence of another vehicle, and the processor selects, from among the plurality of predicted trajectories, a predicted trajectory with a highest risk value for the first target trajectory, and a predicted trajectory with a lowest risk value for the first target trajectory.
(3): In aspect (2), the processor selects, from among the plurality of predicted trajectories, a predicted trajectory based further on indicators other than the risk value.
(4): In aspect (1), the processor further determines whether another vehicle is a risk inducing entity inducing a risk for the own vehicle, or the own vehicle is a risk inducing entity inducing a risk for another vehicle, based on the first target trajectory and a predicted trajectory with a higher risk value for the first target trajectory out of the selected two predicted trajectories. The processor establishes the final predicted trajectory based on different criteria according to the risk inducing entity.
(5): In aspect (4), when another vehicle is the risk inducing entity, the processor establishes the final predicted trajectory based on occurrence probabilities of the selected two predicted trajectories.
(6): In aspect (4), when the own vehicle is the risk inducing entity, the processor establishes the final predicted trajectory based on an occurrence probability and risk value of a predicted trajectory with a lower risk value and a risk value of a predicted trajectory with a higher risk value out of the selected two predicted trajectories.
(7): In aspect (4), the processor determines whether the own vehicle or another vehicle is the risk inducing entity based on whether the first target trajectory or a predicted trajectory with a higher risk value for the first target trajectory has a larger change in behavior.
(8): In aspect (7), when the first target trajectory and a predicted trajectory with a higher risk value for the first target trajectory have substantially the same change in behavior, the processor determines the risk inducing entity by referring to priority information relating to travel lanes of the own vehicle and another vehicle.
(9): In aspect (1), the processor generates, as the second target trajectory, a target trajectory with the minimum total cost taking into account a risk of collision with another vehicle traveling along the established final predicted trajectory, utility indicating a degree of adherence to an arrival target time, and comfort for an occupant of the own vehicle.
(10): A vehicle control method according to another aspect of the present invention is a vehicle control method to be executed by a computer, the vehicle control method including: acquiring a plurality of predicted trajectories of another vehicle traveling near an own vehicle; selecting two predicted trajectories from among the plurality of predicted trajectories based on a first target trajectory of the own vehicle; establishing a final predicted trajectory of another vehicle out of the selected two predicted trajectories based on at least one of an occurrence probability and risk value of the selected two predicted trajectories; generating a second target trajectory of the own vehicle based on the established final predicted trajectory; and
   controlling travel of the own vehicle according to the second target trajectory.
(11): A non-transitory computer-readable storage medium having stored thereon a program for causing a computer to: acquire a plurality of predicted trajectories of another vehicle traveling near an own vehicle; select two predicted trajectories from among the plurality of predicted trajectories based on a first target trajectory of the own vehicle; establish a final predicted trajectory of another vehicle out of the selected two predicted trajectories based on at least one of an occurrence probability and risk value of the selected two predicted trajectories; generate a second target trajectory of the own vehicle based on the established final predicted trajectory; and control travel of the own vehicle according to the second target trajectory.

According to aspects (1) to (11), it is possible to appropriately and robustly control vehicle travel according to the states, predicted intention, and responsibility of other vehicles.

According to aspects (2) and (3), it is possible to extract predicted trajectories effective for predicting the trajectory of another vehicle from among a plurality of predicted trajectories of another vehicle.

According to aspects (4) to (7), it is possible to determine the predicted trajectory of another vehicle more accurately by establishing the final predicted trajectory of another vehicle based on different criteria according to the risk inducing entity.

According to aspect (7), it is possible to accurately determine the risk inducing entity even when the risk inducing entity is difficult to determine only from the behavior of vehicles.

### BRIEF DESCRIPTION OF THE DRAWINGS

FIG. 1 is a diagram illustrating an example of the configuration of a system including an own vehicle and a vehicle control device.

FIG. 2 is a diagram for explaining a calculation method for utility to be used for generating a first target trajectory of the own vehicle by a first target trajectory generation unit.

FIG. 3 is a diagram for explaining a calculation method for comfort to be used for generating the first target trajectory of the own vehicle by the first target trajectory generation unit.

FIG. 4 is a diagram for explaining a method for selecting a predicted trajectory by a predicted trajectory selection unit.

FIG. 5 is a diagram for explaining a method for determining a risk inducing entity by a risk inducing entity determination unit.

FIG. 6 is another diagram for explaining a method for determining a risk inducing entity by the risk inducing entity determination unit.

FIG. 7 is a diagram illustrating an example of a second target trajectory to be generated by a second trajectory generation unit.

FIG. 8 is a diagram for explaining a method for coordinating risk inducing entity determination by the risk inducing entity determination unit.

FIG. 9 is a flow chart illustrating an example of a flow of processing executed by a vehicle control device.

FIG. 10 is a flow chart illustrating an example of a flow of processing executed by the risk inducing entity determination unit.

### DESCRIPTION OF EMBODIMENTS

In the following, an embodiment of the vehicle control device, vehicle control method, and program of the present invention will be described below with reference to the drawings. In this embodiment, a “vehicle” refers to any type of vehicle, including passenger cars, trucks, trailers, agricultural vehicles, and work vehicles. From the perspective of the power source, the vehicle may be, for example, a gasoline-powered vehicle, a hybrid vehicle, an electric vehicle, or a fuel cell vehicle. Furthermore, in this embodiment, the vehicle is configured to be capable of autonomous travel and may therefore be unmanned; however, an operator may also be onboard. In the following description, a passenger car is used as an example of the vehicle.

### [Overall Configuration]

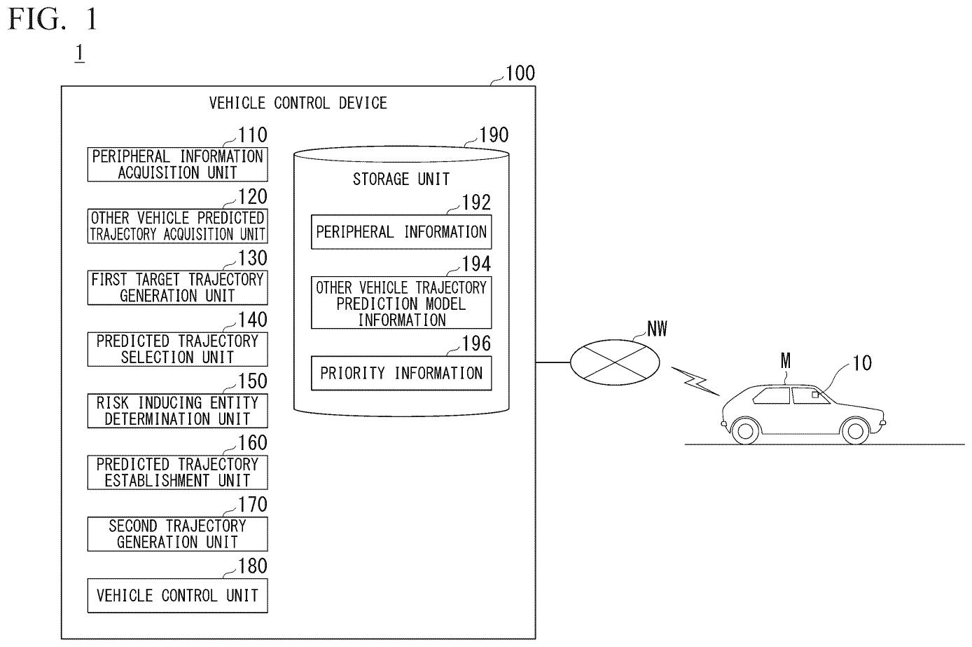

FIG. 1 is a diagram illustrating an example of the configuration of a system 1 including an own vehicle M and a vehicle control device 100. The vehicle control device 100 communicates with the own vehicle M via a network NW and executes travel control for the own vehicle M. The network NW includes the Internet, a wide area network (WAN), a local area network (LAN), public telephone lines, provider equipment, dedicated lines, wireless base stations, or other communication infrastructures.

As another example, the vehicle control device 100 may be installed in the own vehicle M, and the network NW may be omitted. In the following description, it is assumed that a camera 10 installed in the own vehicle M transmits captured images to the vehicle control device 100 via the network NW. However, if the vehicle control device 100 is installed in the own vehicle M, the vehicle control device 100 can directly acquire and process the captured images immediately.

The camera 10 is a digital camera that utilizes a solid-state imaging device such as a CCD (Charge Coupled Device) or a CMOS (Complementary Metal Oxide Semiconductor). One or more cameras 10 are mounted at arbitrary locations on the own vehicle M. When capturing the front area of the own vehicle M, the camera 10 is installed on the upper part of the front windshield or the back of the rearview mirror. When capturing the side and rear areas of the own vehicle M, the camera 10 is mounted on the door mirrors or other suitable locations. The camera 10 periodically captures images of the surroundings of the own vehicle M. The camera 10 may also be a stereo camera. The camera 10 transmits the captured peripheral images to the vehicle control device 100 via the network NW.

The own vehicle M may be equipped with a radar device and/or LIDAR in addition to or instead of the camera 10. The radar device emits radio waves, such as millimeter waves, around the own vehicle M and detects the radio waves reflected by peripheral objects (reflected waves) to determine at least the position (distance and direction) of the objects. The LIDAR irradiates light around the own vehicle M and measures the scattered light. The LIDAR detects the distance to a target based on the time from emission to reception of the light. The emitted light is, for example, pulsed laser light.

The vehicle control device 100 includes, for example, a peripheral information acquisition unit 110, a vehicle predicted trajectory acquisition unit 120, a first target trajectory generation unit 130, a predicted trajectory selection unit 140, a risk inducing entity determination unit 150, a predicted trajectory establishment unit 160, a second trajectory generation unit 170, a vehicle control unit 180, and a storage unit 190. The peripheral information acquisition unit 110, the vehicle predicted trajectory acquisition unit 120, the first target trajectory generation unit 130, the predicted trajectory selection unit 140, the risk inducing entity determination unit 150, the predicted trajectory establishment unit 160, the second trajectory generation unit 170, and the vehicle control unit 180 are each implemented by a hardware processor such as a CPU (Central Processing Unit) executing a program (software). A part or all of the components may be implemented by hardware (circuit; including circuitry) such as an LSI (Large Scale Integration), an ASIC (Application Specific Integrated Circuit), an FPGA (Field-Programmable Gate Array), or a GPU (Graphics Processing Unit), or may be implemented by cooperation between software and hardware. The program may be stored in advance in a storage device (storage device including a non-transitory storage medium) of the vehicle control device 100 such as an HDD or a flash memory, or the program may be stored in a removable storage medium such as a DVD or a CD-ROM. Then, the storage medium (non-transitory storage medium) may be mounted on a drive device so that the program is installed into an HDD or a flash memory of the vehicle control device 100.

The storage unit 190 may be implemented using various storage devices mentioned above, or with EEPROM (Electrically Erasable Programmable Read-Only Memory), ROM (Read-Only Memory), RAM (Random Access Memory), or similar memory types. The storage unit 190 stores, for example, peripheral information 192, other vehicle trajectory prediction model information 194, and priority information 196. Additionally, the storage unit 190 may store other necessary information for executing travel control in this embodiment, such as map information, various other types of information, and programs.

### [Acquisition of Other Vehicle Predicted Trajectories]

The peripheral information acquisition unit 110 acquires peripheral images of the own vehicle M in time series from the camera 10 via the network NW, and stores the peripheral images into the storage unit 190 as the peripheral information 192. When the own vehicle M is equipped with a radar device or LIDAR, the peripheral information acquisition unit 110 may store the detection results from the radar device or LIDAR into the storage unit 190 as the peripheral information 192.

The vehicle predicted trajectory acquisition unit 120 acquires a plurality of predicted trajectories of another vehicle traveling near the own vehicle M by, for example, inputting the peripheral information 192 into the other vehicle trajectory prediction model information 194. In this embodiment, “trajectory” (including target trajectory and predicted trajectory) consists of a driving path and velocity profile of the own vehicle M or other vehicles. The driving path means a combination of trajectory points that the vehicle T is to pass through in the future (without velocity information), and the velocity profile means information specifying the velocity when the vehicle T passes through the driving path. The other vehicle trajectory prediction model information 194 is a machine learning model trained to generate multiple predicted trajectories of another vehicle, as well as occurrence probabilities of those predicted trajectories, when time-series peripheral images including another vehicle are input. Here, the predicted trajectory represents the time-series transition of the position and velocity of another vehicle at future time points. The other vehicle trajectory prediction model information 194, which has such functionality, can be configured using a network based on RNN (Recurrent Neural Network) models that consider time series, such as LSTM (Long Short-Term Memory), as well as CNN (Convolutional Neural Networks) or Transformer-based networks. In another aspect, the other vehicle trajectory prediction model information 194 can also be configured using Bayesian filters, such as a Kalman filter (KF), an extended Kalman filter (EKF), an unscented Kalman filter (UKF), or a particle filter, with or without a map-based route. Additionally, in another aspect, the other vehicle trajectory prediction model information 194 can be configured using kinematic models, such as a constant velocity model, a constant angle model, a constant acceleration model, or a constant turn rate model, with or without a map-based route.

### [Generation of First Target Trajectory]

The first target trajectory generation unit 130 generates a target trajectory for the own vehicle M without considering existence of another vehicle. For example, the first target trajectory generation unit 130 generates a target trajectory that maximizes a gain, which is a sum of utility U indicating a degree of adherence to an arrival target time, and comfort CM for the occupants of the own vehicle M. More specifically, the first target trajectory generation unit 130 generates a target trajectory that maximizes G=utility U+comfort CM. In generation of the first target trajectory, the first target trajectory generation unit 130 may refer to map information to identify the current location and destination, detect a drivable space (e.g., space within road lane markings) from the peripheral image captured by the camera 10, and generate a target trajectory from the current location to the destination within the drivable space.

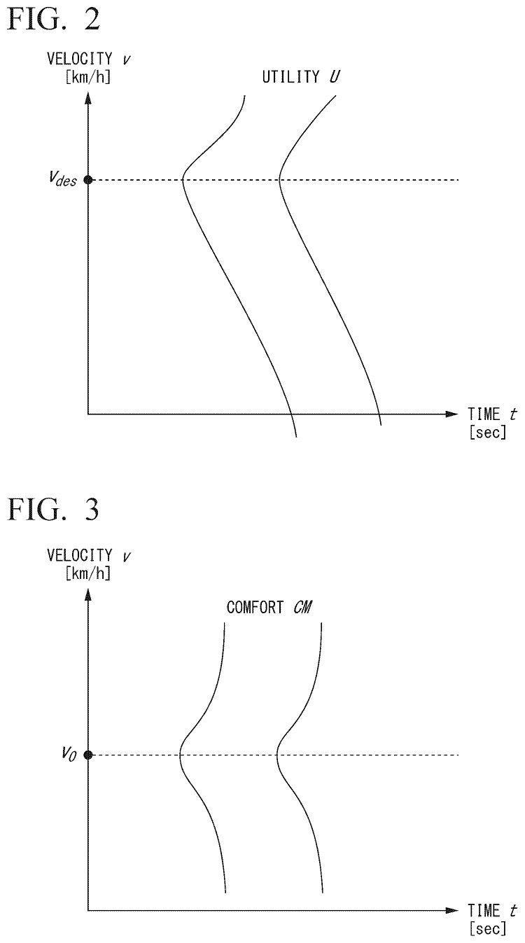

FIG. 2 is a diagram for explaining a calculation method for utility to be used for generating a first target trajectory of the own vehicle M by the first target trajectory generation unit 130. FIG. 2 is a graph with the future time t from the current time point on the horizontal axis and the velocity v on the vertical axis. In FIG. 2, the symbol v_{des} represents the target velocity for the own vehicle M to arrive at the destination on time. Since this embodiment assumes that the own vehicle M is traveling autonomously, the destination and arrival time are set in advance. FIG. 2 represents the level of the utility U with respect to a combination of the future time t and the velocity v, and as shown in the graph in FIG. 2, as an example, the utility U is calculated such that the closer the velocity is to v_{des}, the larger the value becomes. The target velocity v_{des} may be appropriately updated based on the current position of the own vehicle M and the distance to the destination at a timing when the first target trajectory generation unit 130 calculates the utility. Furthermore, the calculation method in FIG. 2 is just an example, and as an alternative embodiment, the utility U may be calculated in such a way that the earlier the arrival time at the destination (within the speed limit), the larger the value becomes.

FIG. 3 is a diagram for explaining a calculation method for comfort to be used for generating the first target trajectory of the own vehicle M by the first target trajectory generation unit 130. FIG. 3 is a graph with the future time t from the current time point on the horizontal axis and the velocity v on the vertical axis. FIG. 3 represents the level of the comfort CM with respect to a combination of the future time t and the velocity v, and as shown in the graph of FIG. 3, as an example, the comfort CM is calculated such that the smaller the variation from the current velocity (v₀), meaning the smaller the acceleration and/or jerk, the larger the value becomes. The calculation method shown in FIG. 3 is merely an example, and in other embodiments, the comfort CM may be calculated by considering, for instance, the number of lane changes (discrete value), with more lane changes resulting in a smaller value.

### [Selection of Predicted Trajectory]

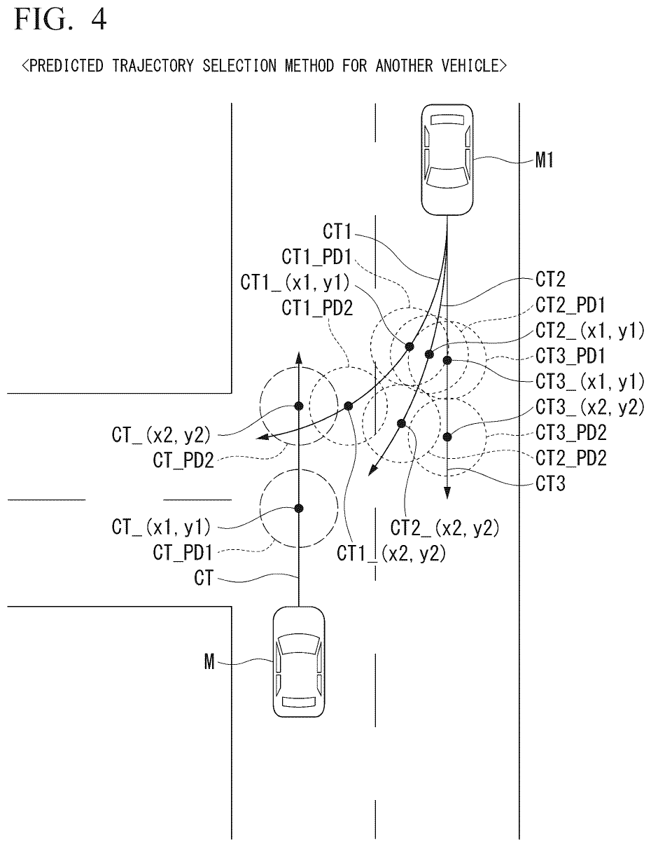

The predicted trajectory selection unit 140 selects two predicted trajectories from among the plurality of predicted trajectories of another vehicle based on the first target trajectory of the own vehicle M. FIG. 4 is a diagram for explaining a method for selecting a predicted trajectory by the predicted trajectory selection unit 140. In FIG. 4, the symbol M1 represents another vehicle, the symbol CT represents the first target trajectory generated by the first target trajectory generation unit 130, and the symbols CT1 to CT3 represent a plurality of predicted trajectories of another vehicle M1 acquired by the vehicle predicted trajectory acquisition unit 120.

Furthermore, as shown in FIG. 4, the first target trajectory CT includes a trajectory point CT_(xₜ, yₜ), which represents the target location (namely, coordinates (xₜ, yₜ)) at an future time t (sec) from the current time point, and the predicted trajectories CT1 to CT3 include trajectory points CT1_(xₜ, yₜ) to CT3_(xₜ, yₜ), which represent the predicted locations at a future time t (sec) from the current time point. Since the trajectory points CT_(xₜ, yₜ) represent target locations at each future time t from the current time point, a series of the trajectory points CT_(xₜ, yₜ) on the trajectory candidate CT correspond to a velocity profile of the own vehicle M. On the other hand, since the trajectory points CT1_(xₜ, yₜ) to CT3_(xₜ, yₜ) represent predicted locations at a future time t (sec) from the current time point, a series of trajectory points CT1_(xₜ, yₜ) to CT3_(xₜ, yₜ) on the predicted trajectories CT1 to CT3 correspond to predicted velocities along the predicted trajectories.

The predicted trajectory selection unit 140 selects, from among the plurality of predicted trajectories as two predicted trajectories, a predicted trajectory with a highest risk value for the first target trajectory CT, and a predicted trajectory with a lowest risk value for the first target trajectory CT. More specifically, the predicted trajectory selection unit 140 models each of the first target trajectory CT and the plurality of predicted trajectories CT1 to CT3 as a probability distribution, such as a two-dimensional Gaussian distribution or a Poisson distribution. For example, in the case of the first target trajectory CT, the predicted trajectory selection unit 140 models the behavior of the own vehicle M as a probability distribution CT_PD centered on each trajectory point CT_(xₜ, yₜ) of the first target trajectory CT. Similarly, in the case of each of the predicted trajectories CT1 to CT3, the predicted trajectory selection unit 140 models the behavior of another vehicle M1 as probability distributions CT1_PD to CT3_PD centered on respective trajectory points CT1_(xₜ, yₜ) to CT3_(xₜ, yₜ) of the predicted trajectories CT1 to CT3. The predicted trajectory selection unit 140 can calculates a risk R of collision between the first target trajectory CT and each of the predicted trajectories CT1 to CT3 as a value proportional to the product of the probability distributions (survival analysis). For example, the predicted trajectory selection unit 140 can calculate the collision risk R by taking a sum of products of the probability distribution of another vehicle M1 and the probability distribution of the own vehicle M in a time series, or can acquire the collision risk R by setting, as the collision risk R, the maximum value among the products of the probability distribution of another vehicle M1 and the probability distribution of the own vehicle M. For example, in the case of FIG. 4, the predicted trajectory selection unit 140 selects, from among the predicted trajectories CT1 to CT3, the predicted trajectory CT1 as a predicted trajectory with a highest risk for the first target trajectory CT, and the predicted trajectory CT3 as a predicted trajectory with a lowest risk for the first target trajectory CT. For details of survival analysis, see T. Puphal et al., “Online and predictive warning system for forced lane changes using risk maps” for reference.

In another aspect, the predicted trajectory selection unit 140 may select two predicted trajectories based on different criteria. For example, the predicted trajectory selection unit 140 may select a predicted trajectory with a highest occurrence probability and highest risk value (e.g., predicted trajectory with largest sum of occurrence probability and risk value) and a predicted trajectory with a smallest behavioral change (e.g., predicted trajectory with smallest curvature change, velocity change, or acceleration change) and a low risk value. Additionally, the risk analysis is not limited to the described survival analysis, and may utilize any analytical method, such as the common time-to-collision (TTC) analysis or responsibility-sensitive safety (RSS) analysis. Through the processing by the predicted trajectory selection unit 140, predicted trajectories effective for predicting the movement of other vehicles can be extracted from a plurality of predicted trajectories of another vehicle. Hereinafter, of the two predicted trajectories selected by the predicted trajectory selection unit 140, the one with the higher risk value is referred to as “high risk predicted trajectory,” while the one with the lower risk value is referred to as “low risk predicted trajectory”.

In another aspect, the predicted trajectory selection unit 140 may calculate indicators other than the risk, such as the utility U and comfort CM, for each predicted trajectory of another vehicle, and use the calculated indicators for selection of a predicted trajectory. For example, the predicted trajectory selection unit 140 may calculate the utility U as a larger value for a predicted trajectory with a larger velocity (this trajectory is expected to allow another vehicle to reach its destination earlier), and thus increase the occurrence probability of that predicted trajectory. Further, for example, the predicted trajectory selection unit 140 may calculate the comfort CM as a larger value for a predicted trajectory with a smaller change in velocity, and thus increase the occurrence probability of that predicted trajectory. Further, for example, the predicted trajectory selection unit 140 may increase the occurrence probability of a predicted trajectory when the predicted trajectory has a smaller change in behavior.

### [Determination of Risk Inducing Entity]

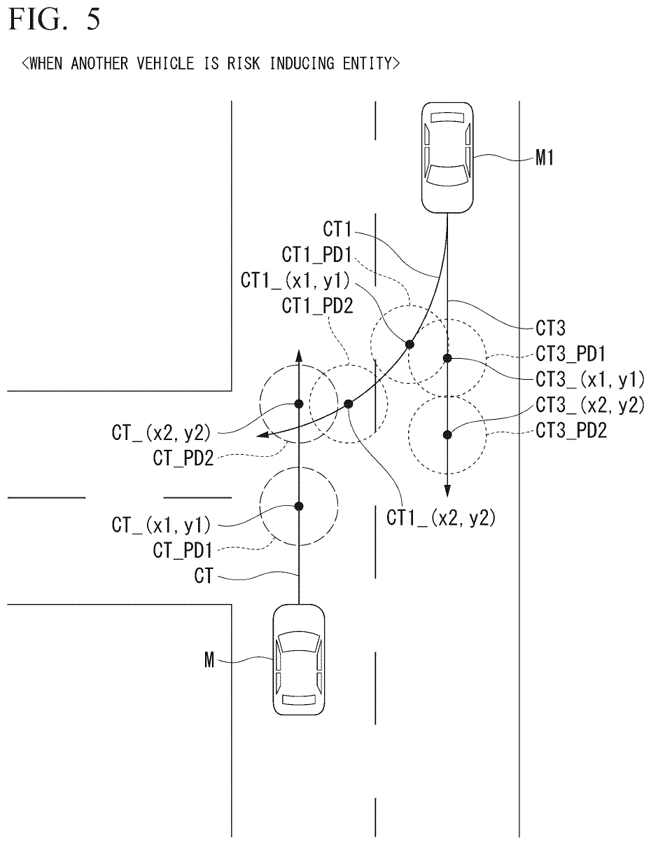

FIG. 5 is a diagram for explaining a method for determining a risk inducing entity by the risk inducing entity determination unit 150. FIG. 5 illustrates the exemplary scene shown in FIG. 4, where the predicted trajectory selection unit 140 selects the predicted trajectory CT1 as the high risk predicted trajectory and the predicted trajectory CT3 as the low risk predicted trajectory. The risk inducing entity determination unit 150 determines, based on the first target trajectory CT and the high risk predicted trajectory CT1, whether another vehicle M1 is a risk inducing entity inducing a risk for the own vehicle M, or the own vehicle M is a risk inducing entity inducing a risk for another vehicle M1. For example, the risk inducing entity determination unit 150 may determine, as the risk inducing entity, one of the own vehicle M and another vehicle M1 with a larger change in behavior.

More specifically, for example, the risk inducing entity determination unit 150 may compare the curvature of the first target trajectory CT and the curvature of the high risk predicted trajectory and determine the one with the greater curvature as the risk inducing entity. In the case of FIG. 5, the risk inducing entity determination unit 150 compares the curvature of the first target trajectory CT and the curvature of the predicted trajectory CT1 being the high risk predicted trajectory, and determines that the predicted trajectory CT1 has a greater curvature. Thus, the risk inducing entity determination unit 150 determines another vehicle M1 as the risk inducing entity.

Additionally, in another aspect, the risk inducing entity determination unit 150 may compare the velocity or acceleration of the first target trajectory CT and the velocity or acceleration of the high risk predicted trajectory, and determine the one with the greater velocity or acceleration change as the risk inducing entity. This is because a higher velocity or acceleration change indicates that the driver intends to prioritize the operation of their own vehicle over that of other vehicles. In another aspect, the risk inducing entity determination unit 150 may assign weights to curvature, velocity, and acceleration, compute their weighted sum, and determine the one with the larger sum as the risk inducing entity. Furthermore, in another aspect, the risk inducing entity determination unit 150 may first determine the risk inducing entity based on curvature, and if the curvature is similar (difference is equal to or smaller than threshold value), then determine the risk inducing entity based on velocity or acceleration.

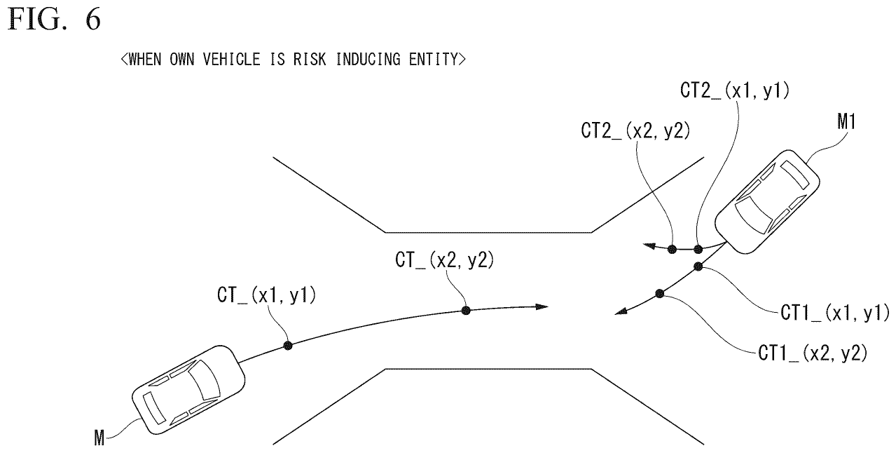

FIG. 6 is another diagram for explaining a method for determining a risk inducing entity by the risk inducing entity determination unit 150. FIG. 6 illustrates an example in which the own vehicle M and the other vehicle M1 are attempting to travel through a narrow road, and the predicted trajectory selection unit 140 selects the predicted trajectory CT1 as the high risk predicted trajectory and the predicted trajectory CT2 as the low risk predicted trajectory from multiple predicted trajectories. For example, the risk inducing entity determination unit 150 first compares the curvature of the first target trajectory CT with that of the predicted trajectory CT1. If the curvature of the first target trajectory CT and that of predicted trajectory CT1 are similar, the risk inducing entity determination unit 150 then compares the velocity of the first target trajectory CT with the velocity of the predicted trajectory CT1, for example. In the case of FIG. 6, the distance change between the trajectory points CT_(x₁, y₁) and CT_(x₂, y₂) after 1 second and 2 seconds, respectively, on the first target trajectory CT is greater than the distance change between the trajectory points CT1_(x₁, y₁) and CT1_(x₂, y₂) after 1 second and 2 seconds on the predicted trajectory CT1. This indicates that the velocity change of the first target trajectory CT is greater than that of the predicted trajectory CT1. Therefore, the risk inducing entity determination unit 150 determines that the own vehicle M is the risk inducing entity.

### [Establishment of Predicted Trajectory]

After the risk inducing entity determination unit 150 determines the risk inducing entity, the predicted trajectory establishment unit 160 establishes a final predicted trajectory of another vehicle based on different criteria according to the determined risk inducing entity. As described below, by establishing the final predicted trajectory of another vehicle based on different criterion and utilizing the determined predicted trajectory for planning the travel of the own vehicle M, the planning of the own vehicle M can be done more robustly.

When the risk inducing entity determination unit 150 has determined that another vehicle is the risk inducing entity, the predicted trajectory establishment unit 160 establishes a final predicted trajectory based on occurrence probabilities of the two predicted trajectories. More specifically, when the symbol p_{M,1} represents the occurrence probability of the high risk predicted trajectory, and the symbol p_{M,2} represents the occurrence probability of the low risk predicted trajectory, the predicted trajectory establishment unit 160 determines whether or not a difference value D=p_{M,1}−p_{M,2} is equal to or larger than a threshold value, and if it is determined that the difference value D is equal to or larger than the threshold value, the predicted trajectory establishment unit 160 establishes the high risk predicted trajectory as the final predicted trajectory. This is because if the difference value D is equal to or larger than the threshold value, the occurrence probability of the high risk predicted trajectory is relatively large, and it would not be appropriate to disregard the high risk predicted trajectory when planning travel of the own vehicle M.

On the other hand, when it is determined that the difference value D is smaller than the threshold value, the predicted trajectory establishment unit 160 establishes the low risk predicted trajectory as the final predicted trajectory. This is because, when the difference value D is smaller than the threshold, it is assumed that, although another vehicle is inducing a risk, it would not be a problem to plan the travel of the own vehicle M assuming that another vehicle will adopt the low risk predicted trajectory. This helps to make the planning(e.g., deceleration) of the own vehicle M more robust against incorrect predictions of machine learning models, thereby reducing the likelihood of discomfort for the occupants of the own vehicle M. The planner will be less sensitive to sudden prediction changes of the predictor (vehicle predicted trajectory acquisition unit 120) by only considering the high risk prediction if the occurrence probability is much higher than other low risk prediction options for the other vehicle.

When the risk inducing entity determination unit 150 has determined that the own vehicle is the risk inducing entity, the predicted trajectory establishment unit 160 establishes the final predicted trajectory based on the occurrence probability and risk value of the low risk predicted trajectory and the risk value of the high risk predicted trajectory. More specifically, when the symbol r_{M,1} represents the risk value of the high risk predicted trajectory and the symbol r_{M,2} represents the risk value of the low risk predicted trajectory, the predicted trajectory establishment unit 160 determines whether or not the occurrence probability p_{M,2} is equal to or smaller than a difference value D=r_{M,1}−r_{M,2}, and when determining that the occurrence probability p_{M,2} is equal to or smaller than the difference value D, establishes the high risk predicted trajectory as the final predicted trajectory. This is because, when the occurrence probability p_{M,2} is equal to or smaller than the difference value D, the occurrence probability of the low risk predicted trajectory is relatively small, and therefore, it would not be appropriate to disregard the high risk predicted trajectory when planning the travel of the own vehicle M.

On the other hand, when it is determined that the occurrence probability p_{M,2} is larger than the difference value D, the predicted trajectory establishment unit 160 establishes the low risk predicted trajectory as the final predicted trajectory. This is because, when the difference value D is larger than the difference value D, it is assumed that, although the own vehicle M is inducing a risk, it would not be a problem to plan the travel of the own vehicle M assuming that another vehicle will adopt the low risk predicted trajectory. This helps to prevent planning the travel (e.g., deceleration) of the own vehicle M based on the incorrect assumption that another vehicle will insist on the high risk predicted trajectory, thereby reducing the likelihood of discomfort for the occupants of the own vehicle M.

The purpose of comparing the occurrence probability p_{M,2} with the difference value D=r_{M,1}−r_{M,2} is to ensure that when the risk value r_{M,1} of the high risk predicted trajectory is high, the high-risk predicted trajectory is established as the final predicted trajectory to guarantee safety. The difference value D=r_{M,1}−r_{M,2} to be compared with the occurrence probability p_{M,2} is not necessarily limited to a difference between the risk value of the high risk predicted trajectory and the risk value of the low risk predicted trajectory, and a predetermined threshold value r_{M,th} may be used to define the difference value D=r_{M,1}−r_{M,th}.

### [Generation of Second Target Trajectory]

The second trajectory generation unit 170 generates a second target trajectory of the own vehicle M based on the final predicted trajectory established by the predicted trajectory establishment unit 160. That is, contrary to the first target trajectory that does not consider existence of another vehicle, the second target trajectory is a target trajectory that considers existence of another vehicle (more specifically, target trajectory that considers the established final predicted trajectory). More specifically, for example, the second trajectory generation unit 170 generates the second target trajectory by searching for a target trajectory with the minimum total cost of risk R, utility U and comfort CM according to C=R−U−CM.

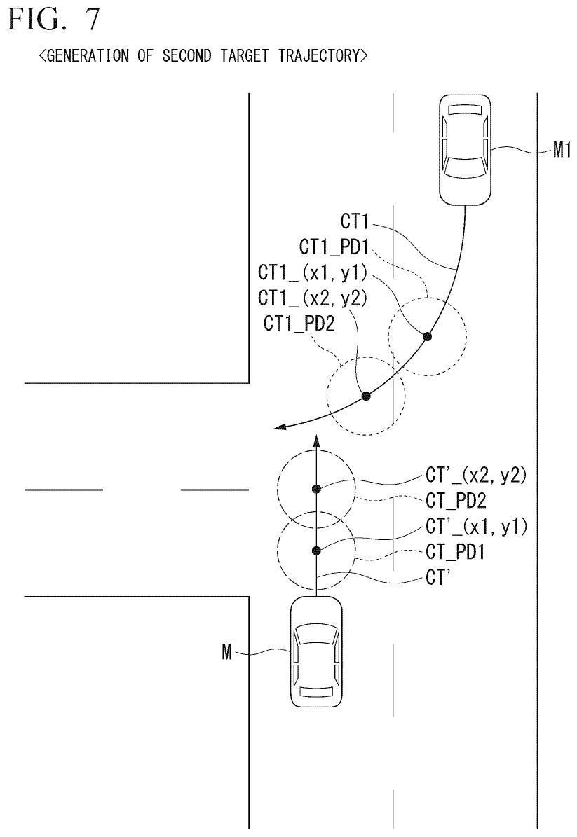

FIG. 7 is a diagram illustrating an example of the second target trajectory to be generated by the second trajectory generation unit 170. FIG. 7 illustrates the exemplary scene from FIG. 5, where the predicted trajectory establishment unit 160 establishes the predicted trajectory CT1, which is the high risk predicted trajectory, as the final predicted trajectory of another vehicle M1. As shown in FIG. 7, the second trajectory generation unit 170 searches for and generates a second target trajectory in such a manner as to reduce the collision risk R with the predicted trajectory CT1 and improve the utility U and the comfort CM based on the established predicted trajectory CT1. FIG. 7 shows an example in which, as a result of the search, the second trajectory generation unit 170 has generated the second target trajectory CT′. Compared with the first target trajectory CT, it is found that the second target trajectory CT′ ensures safety in consideration of the collision risk R while compromising the utility U and the comfort CM, as an example.

In this embodiment, for the sake of explanation, the risk value is calculated only for the collision risk R with other vehicles. However, the present invention is not limited to such a configuration, and more generally, various risk values related to safety for travel of the own vehicle M can be calculated and considered. For example, in addition to the collision risk R, the risk value can be calculated by considering curvature risk (risk of deviating from curve) when the own vehicle M travels on a curved path, or regulatory risk (risk of violating regulations) when entering a region where entry is restricted by law. When considering risks other than the collision risk, the total risk can be calculated by multiplying each risk by its severity, according to its type, and taking a sum of the results.

Furthermore, in this embodiment, for the sake of explanation, it is assumed that there is only one other vehicle. However, the present invention is not limited to such a configuration, and can also be applied in cases where multiple other vehicles are present. More specifically, for each of the multiple other vehicles, multiple predicted trajectories are obtained, from which two are selected, and then, the risk inducing entity is determined, and the final predicted trajectory is established. Next, assuming that there are multiple final predicted trajectories established for the multiple other vehicles, the second trajectory generation unit 170 generates the second target trajectory by searching for a target trajectory with the minimum total cost C=R−U−CM taking into account the collision risk R, the utility U, and the comfort CM. The collision risk R in this case means, for example, a sum of multiple risk values calculated for the multiple other vehicles, respectively.

### [Vehicle Control]

The vehicle control unit 180 controls a driving force output device, a brake system, and a steering system of the own vehicle M so that the own vehicle M travels according to the second target trajectory generated by the second trajectory generation unit 170. The driving force output device outputs a driving force (torque) to the drive wheels of the vehicle for travel. The driving force output device includes, for example, a combination of an internal combustion engine, an electric motor, and a transmission, along with an ECU (Electronic Control Unit) for controlling these components. The brake system includes, for example, a brake caliper, a cylinder that transmits hydraulic pressure to the brake caliper, an electric motor that generates hydraulic pressure in the cylinder, and a brake ECU that controls the electric motor. The steering system includes, for example, a steering ECU and an electric motor. The electric motor applies force to a rack-and-pinion mechanism to change the direction of the drive wheel.

In the above embodiment, an example was described in which the vehicle control unit 180 controls travel of the own vehicle M according to the second target trajectory generated by the second trajectory generation unit 170. However, the present invention is not limited to such a configuration, and may also be applied to driver assistance. For example, a navigation system or HMI (Human-Machine Interface) installed in the own vehicle M may display the second target trajectory generated by the second trajectory generation unit 170. This allows the driver to recognize a trajectory that guarantees safety while ensuring convenience, even when the own vehicle M is manually driven by the driver.

### [Coordination of Risk Inducing Entity Determination]

As described above, the risk inducing entity determination unit 150 determines, based on the first target trajectory CT and the high risk predicted trajectory CT1, whether another vehicle M1 is a risk inducing entity inducing a risk for the own vehicle M, or the own vehicle M is a risk inducing entity inducing a risk for another vehicle M1. However, when focusing only on the behavior of the trajectory, the risk inducing entity cannot be determined appropriately in some cases, for example, when the first target trajectory CT and the high risk predicted trajectory CT1 have similar values of velocity change, acceleration change, and jerk change. In such cases, the risk inducing entity determination unit 150 can coordinate determination of the risk inducing entity based on a criterion other than parameters related to the trajectory. Coordination herein refers to determining a risk inducing entity inducing based on other criteria when it is impossible to determine the risk inducing entity based on the behavior of the trajectory.

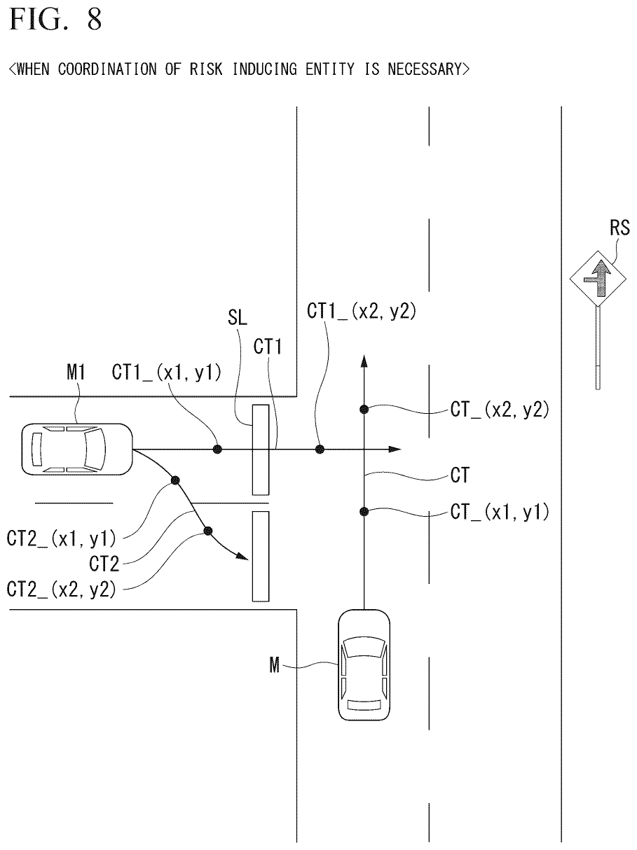

FIG. 8 is a diagram for explaining a method for coordinating risk inducing entity determination by the risk inducing entity determination unit 150. FIG. 8 illustrates an example in which the first target trajectory CT and the predicted trajectory CT1, which is the high risk predicted trajectory, have similar curvature, velocity change, and acceleration change, resulting in only minor value differences. In such cases, the risk inducing entity determination unit 150 can refer to the priority information 196 stored in the storage unit 190 to determine the risk inducing entity.

The priority information 196 may be, for example, data that associates the priority of each road with its position data within the road structure, or may indicate which road has priority at connection points between multiple roads. For example, in the scene shown in FIG. 8, the priority information 196 indicates that the straight path at a T-junction has priority. Therefore, the risk inducing entity determination unit 150 determines that the road on which the own vehicle M is traveling has priority, and consequently, another vehicle M1 is identified as the risk inducing entity.

Alternatively, in another aspect, the risk inducing entity determination unit 150 may determine the priority based on an image captured by the camera 10 without referring to the priority information 196. For example, the risk inducing entity determination unit 150 may identify, from the image, the priority sign PS for the road on which the own vehicle M is travelling or a stopping line for the road on which another vehicle is traveling. The risk inducing determination unit 150 may then determine that the vehicle traveling on the stopping lane is the risk inducing entity. As another example, the risk inducing entity determination unit 150 may identify, from the image, the width of a road on which the own vehicle M is traveling and the width of a road on which another vehicle is traveling. The risk inducing entity determination unit 150 may then determine that the vehicle traveling on the narrower road is the risk inducing entity. In this way, according to this aspect, even when it is difficult to determine the risk inducing entity based on vehicle behavior alone, the determination can still be performed accurately.

### [Flow of Processing]

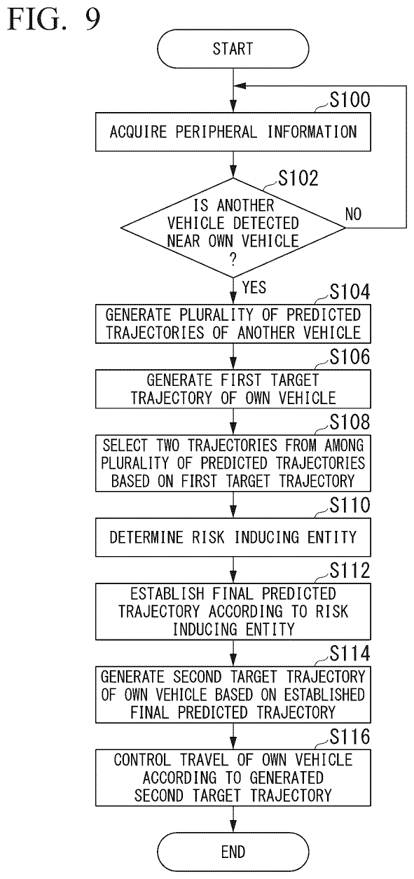

Now, a flow of processing to be executed by the vehicle control device 100 is described with reference to FIG. 9. FIG. 9 is a flow chart illustrating an example of a flow of processing executed by the vehicle control device 100. The processing of the flow chart illustrated in FIG. 9 is repeatedly executed during travel of the own vehicle M.

First, the peripheral information acquisition unit 110 acquires the peripheral information 192 (Step S100). Next, the peripheral information acquisition unit 110 determines whether or not another vehicle is detected near the own vehicle M based on the peripheral information 192 (Step S102). When it is determined that another vehicle is not detected near the own vehicle M, the peripheral information acquisition unit 110 returns the processing to Step S100. On the other hand, when it is determined that another vehicle is detected near the own vehicle M, the vehicle predicted trajectory acquisition unit 120 acquires a plurality of predicted trajectories of another vehicle (Step S104).

Next, the first target trajectory generation unit 130 generates the first target trajectory of the own vehicle M (Step S106). Next, the predicted trajectory selection unit 140 selects two predicted trajectories from among the plurality of predicted trajectories based on the first target trajectory of the own vehicle M (Step S108). Next, the risk inducing entity determination unit 150 determines the risk inducing entity out of the own vehicle M and another vehicle based on the first target trajectory and the predicted trajectories (Step S110).

Next, the predicted trajectory establishment unit 160 establishes the final predicted trajectory of another vehicle according to the risk inducing entity (Step S112). Next, the second trajectory generation unit 170 generates the second target trajectory of the own vehicle M based on the established final predicted trajectory (Step S114). Next, the vehicle control unit 180 controls travel of the own vehicle M according to the generated second target trajectory (Step S116). This concludes the processing of this flow chart. In the flow chart illustrated in FIG. 9, the execution order of the processing of Step S104 and the processing of Step S106 may be replaced with each other, or the processing of Step S104 and the processing of Step S106 may be executed at the same time.

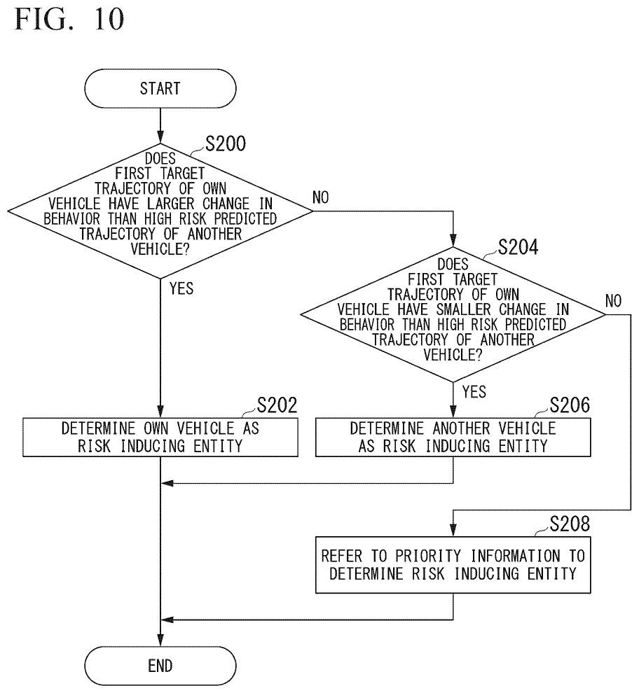

FIG. 10 is a flow chart illustrating an example of a flow of processing executed by the risk inducing entity determination unit 150. The processing of the flow chart illustrated in FIG. 10 is executed in the processing of Step S110 in the flow chart illustrated in FIG. 9.

First, the risk inducing entity determination unit 150 determines whether the first target trajectory of the own vehicle M has a larger change in behavior than the high risk predicted trajectory of another vehicle (Step S200). When it is determined that the first target trajectory of the own vehicle M has a larger change in behavior than the high risk predicted trajectory of another vehicle, the risk inducing entity determination unit 150 determines that the own vehicle M is the risk inducing entity (Step S202). On the other hand, when it is determined that the first target trajectory of the own vehicle M does not have a larger change in behavior than the high risk predicted trajectory of another vehicle, the risk inducing entity determination unit 150 then determines whether the first target trajectory of the own vehicle M has a smaller change in behavior than the high risk predicted trajectory of another vehicle (Step S204).

When it is determined that the first target trajectory of the own vehicle M has a smaller change in behavior than the high risk predicted trajectory of another vehicle, the risk inducing entity determination unit 150 determines that another vehicle is the risk inducing entity (Step S206). On the other hand, when it is determined that the first target trajectory of the own vehicle M does not have a smaller change in behavior than the high risk predicted trajectory of another vehicle, this means the first target trajectory of the own vehicle M and the high risk predicted trajectory of another vehicle have the same degree of change (difference is equal to or smaller than threshold value). Thus, the risk inducing entity determination unit 150 refers to the priority information 196 to determine the risk inducing entity (Step S208). This concludes the processing of this flow chart.

In the flowchart of FIG. 10, the risk inducing entity determination unit 150 switches the processing depending on whether the first target trajectory of the own vehicle M has a larger change in behavior, has the same degree of change in behavior, or has a smaller change in behavior. In another aspect, the risk inducing entity determination unit 150 may set a range for determination of the risk inducing entity. For example, the risk inducing entity determination unit 150 may determine the own vehicle M as the risk inducing entity when the change in behavior of the first target trajectory of the own vehicle M is larger than the change in behavior of the high risk predicted trajectory of another vehicle by more than a first setting value, determine another vehicle as the risk inducing entity when the change in behavior of the first target trajectory of the own vehicle M is smaller than the change in behavior of the high risk predicted trajectory of another vehicle by more than a second setting value, or refer to the priority information 196 to determine the risk inducing entity if the difference falls within the range of from the second setting value to the first setting value.

According to the embodiment described above, two predicted trajectories are selected from among a plurality of predicted trajectories of another vehicle, and then the final predicted trajectory of another vehicle is established according to a relationship with the first target trajectory of the own vehicle M, to thereby plan and control travel of the own vehicle M based on the established final predicted trajectory. Therefore, it is possible to appropriately control vehicle travel according to the states and predicted intent of other vehicles.

The embodiment described above can be represented in the following manner.

A vehicle control device comprising a storage medium having stored thereon computer-readable instructions and a processor connected to the storage medium, the processor executing the computer-readable instructions to:
acquire a plurality of predicted trajectories of another vehicle traveling near an own vehicle;
select two predicted trajectories from among the plurality of predicted trajectories based on a first target trajectory of the own vehicle;
establish a final predicted trajectory of another vehicle out of the selected two predicted trajectories based on at least one of an occurrence probability and risk value of the selected two predicted trajectories;
generate a second target trajectory of the own vehicle based on the established final predicted trajectory; and
control travel of the own vehicle according to the second target trajectory.

Although the embodiments for implementing the present invention have been described using specific examples, the present invention is not limited to these embodiments. Various modifications and substitutions can be made without departing from the spirit and scope of the invention.

What is claimed is:

1. A vehicle control device comprising a storage medium having stored thereon computer-readable instructions and a processor connected to the storage medium, the processor executing the computer-readable instructions to:
acquire a plurality of predicted trajectories of another vehicle traveling near an own vehicle;
select two predicted trajectories from among the plurality of predicted trajectories based on a first target trajectory of the own vehicle;
establish a final predicted trajectory of another vehicle out of the selected two predicted trajectories based on at least one of an occurrence probability and risk value of the selected two predicted trajectories;
generate a second target trajectory of the own vehicle based on the established final predicted trajectory; and
control travel of the own vehicle according to the second target trajectory.

2. The vehicle control device according to claim 1,
wherein the first target trajectory of the own vehicle is a target trajectory that does not consider existence of another vehicle, and
wherein the processor selects, from among the plurality of predicted trajectories, a predicted trajectory with a highest risk value for the first target trajectory, and a predicted trajectory with a lowest risk value for the first target trajectory.

3. The vehicle control device according to claim 2, wherein the processor selects, from among the plurality of predicted trajectories, a predicted trajectory based further on indicators other than the risk value.

4. The vehicle control device according to claim 1,
wherein the processor further determines whether another vehicle is a risk inducing entity inducing a risk for the own vehicle, or the own vehicle is a risk inducing entity inducing a risk for another vehicle, based on the first target trajectory and a predicted trajectory with a higher risk value for the first target trajectory out of the selected two predicted trajectories,
wherein the processor establishes the final predicted trajectory based on different criteria according to the risk inducing entity.

5. The vehicle control device according to claim 4, wherein when another vehicle is the risk inducing entity, the processor establishes the final predicted trajectory based on occurrence probabilities of the selected two predicted trajectories.

6. The vehicle control device according to claim 4, wherein when the own vehicle is the risk inducing entity, the processor establishes the final predicted trajectory based on an occurrence probability and risk value of a predicted trajectory with a lower risk value and a risk value of a predicted trajectory with a higher risk value out of the selected two predicted trajectories.

7. The vehicle control device according to claim 4, wherein the processor determines whether the own vehicle or another vehicle is the risk inducing entity based on whether the first target trajectory or a predicted trajectory with a higher risk value for the first target trajectory has a larger change in behavior.

8. The vehicle control device according to claim 7, wherein when the first target trajectory and a predicted trajectory with a higher risk value for the first target trajectory have substantially the same change in behavior, the processor determines the risk inducing entity by referring to priority information relating to travel lanes of the own vehicle and another vehicle.

9. The vehicle control device according to claim 1, wherein the processor generates, as the second target trajectory, a target trajectory with the minimum total cost taking into account a risk of collision with another vehicle traveling along the established final predicted trajectory, utility indicating a degree of adherence to an arrival target time, and comfort for an occupant of the own vehicle.

10. A vehicle control method to be executed by a computer, the vehicle control method comprising:
acquiring a plurality of predicted trajectories of another vehicle traveling near an own vehicle;
selecting two predicted trajectories from among the plurality of predicted trajectories based on a first target trajectory of the own vehicle;
establishing a final predicted trajectory of another vehicle out of the selected two predicted trajectories based on at least one of an occurrence probability and risk value of the selected two predicted trajectories;
generating a second target trajectory of the own vehicle based on the established final predicted trajectory; and
controlling travel of the own vehicle according to the second target trajectory.

11. A non-transitory computer-readable storage medium having stored thereon a program for causing a computer to:
acquire a plurality of predicted trajectories of another vehicle traveling near an own vehicle;
select two predicted trajectories from among the plurality of predicted trajectories based on a first target trajectory of the own vehicle;
establish a final predicted trajectory of another vehicle out of the selected two predicted trajectories based on at least one of an occurrence probability and risk value of the selected two predicted trajectories;
generate a second target trajectory of the own vehicle based on the established final predicted trajectory; and
control travel of the own vehicle according to the second target trajectory.
